(19) United States
(12) Patent Application Publication
(10) Pub. No.: US 2002/0097299 A1
(43) Pub. Date: Jul. 25, 2002

(54) Liquid ejection print head

(76) Inventor: Makoto Terui, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/023,932

(22) Filed: Dec. 21, 2001

(30) Foreign Application Priority Data
Dec. 21, 2000 (JP) 2000-389249

(51) Int. Cl. B41J 2/14

(52) U.S. Cl. 347/50

(57) ABSTRACT

The base 30 is supported by the branches 36m and the reinforcing portion 36b of the conductive layer 36 on which the tape member layer 32 is stacked.

This application is based on Patent Application No. 2000-389249 filed Dec. 21, 2000 in Japan, the content of which is incorporated hereinto by reference

### BACKGROUND OF THE INVENTION

1. Field of the Invention

The present invention relates to a liquid ejection print head which performs printing by ejecting a print liquid onto a printing surface of a print medium, and a tape provided with a base used for the same.

2. Description of the Related Art

A liquid ejection printing head, for example, an ink-jet printing head of a side shooter type, as shown in Fig, 11 and FIG. 12, includes a body having an ink supply portion a to which ink tank not shown is mounted; a print element board 14 bonded to a bottom of a recessed portion 8b of the ink supply portion 8 to eject ink; and a frame member 3 having an opening 2a opposing the print element board 24 and electrically connected to each electrode of the print element board 14.

The bottom of the recessed portion 8b of the ink supply portion 8 is formed into flat shape by a metal core member 10 which is molded together with the body. At a periphery of the recessed portion 8b of the ink supply portion 8 is securely attached the frame member 3.

At the bottom of the recessed portion 8b of the ink supply portion 8 is opened one end of an ink supply passage 8a that introduces ink from the ink tank. The cross-section shape of the ink supply passage 8a is shaped like a slot extending over a predetermined distance along the arrays of ink ejection ports described later.

The print element board 14 includes; a base 16 having an ink supply opening 14a communicating with an open end of the ink supply passage 8a in the ink supply portion 8 and a plurality of heaters arranged therein; and an orifice plate 12 having a plurality of ink supply branch passages 12bi for introducing ink from the ink supply opening 14a to each heater.

A plurality of heaters are arranged at both sides of the ink supply opening 14a so that they sandwich the ink supply opening 14a, at predetermined intervals in a line extending in a direction almost perpendicular to the paper plane of the drawing.

The base 16 has electrode portions 16d to which connecting portions 6a, 6b described later are connected at one end corresponding to each heater.

The orifice plate 12 has ink ejection ports 12ai formed at positions facing each heater in the base 16. The ink branch supply passages 12bi are provided individually for each heater in the base 16.

The print element board 14 and the frame member 3 are electrically connected to each other by the tape automated bonding (TAB) system, for the example. The frame member 3 includes a tape member 2 with an opening 2a and a conductive layer 6 bonded by an adhesive layer 4 to an entire surface of the tape member 2 on the ink supply portion 8-side.

The tape member 2 is formed of resin, and the conductive layer 6 is formed of a metal sheet 20-30 μM in thickness. The periphery of the opening 2a encloses an area corresponding to the outer circumferential portion of the print element board 14 installed below. The conductive layer 6 has an opening 6A at a position corresponding to the opening 2a and also has a plurality of connecting portions 6a, 6b electrically connected to the corresponding electrode portions 16d of the base 16 of the print element board 14. One end of narrow two or more connecting portions 6a, 6b extend from the periphery of the opening 6A of the conductive layer 6 to the corresponding each electrode portions 16d, respectively.

A gap between the periphery of the opening 2a of the tape member 2 and the outer circumferential portion of the print element board 14 is sealed with a sealant 18. The sealant 18 covers the plurality of connecting portions 6a. 6b and encloses the print element board 14.

Arranging the print element board 14 to face the opening 2a of the tape member 2 of the frame member 3 and making electrical connections between them is performed as follows. First, the print element board 14 is located and positioned at a position relative to the opening 2a of the tape member 2 as by image processing or the like. Then, for example, one end of the connecting portions 6a, 6b are bonded to the electrode portions 16d of the base 16 of the print element board 14 as by thermocompression or ultrasonic vibration.

Then, the print element board 14 connected with the frame member 3 through the connecting portions 6a, 6b is positioned on and secured to the top surface of the ink supply portion 8. As a result, the print element board 14 is relatively positioned relative to and reliably secured to the bottom of the recessed portion 8b of the ink supply portion 8.

When the connecting portions 6a, 6b are bonded to the electrode portions 16d of the base 16, lead forming is done together with the bonding. The lead forming is defined as a process of correcting the amount of deformation of the connecting portions 6a, 6b to avoid the connecting portions 6a, 6b contacting with the edge of the base 16 (edge touch) as shown in FIG. 13A and thereby prevent a short-circuit from occurring at time of operation.

When a gang bonder is used, an amount of the lead forming is expressed based on a relative difference in height between the conductive layer 6 of the frame member 3 and the upper surface of the base 16, Lfa and Lfb, for the example, as shown in FIG. 13B and FIG. 13C. Hence, the amount of lead forming for the height difference Lfa is larger than that for the height difference Lfb.

After having been subjected to a predetermined amount of lead forming, the frame member 3 and the print element board 14 coupled mutually through the connecting portions 6a, 6b are arranged at predetermined positions in the ink supply portion 8.

In the process of assembly, however, because the lead forming are performed in state of keeping the frame member 3 and the print element board 14, and the ink supply portion 8 separated, and the print element board 14 is supported only by the elongate connecting portions 6a, 6b and the connecting portions 6a, 6b have insufficient rigidity and are easily deformed, with result that the amount of lead forming may vary from one print head to another.

When there are variations in the amount of lead forming, there are attended with the following problems.

Firstly, since the variations in the amount of lead forming results in variations in the amount of the gap between the periphery of the opening 2a of the tape member 2 and the outer circumferential portion of the print element board 14, the sealant 18 is not applied uniformly, resulting in a defective sealing of the connecting portions 6a, 6b, which in turn leads to in become a cause of a corrosion. To avoid such a situation, in some case, it can be considered that the amount of sealant 18 applied may be increased. But, this is not a good idea to be taken as it might clog the ejection opening with the sealant 18.

Secondly, when the frame member 3 is bonded to the ink supply portion 8,

Upon bonding the frame member 3 to the ink supply portion 8with reference to the bonding surface of the frame member 3, the gap between the base 16 of the print element board 14 and the bottom of the recessed portion 8b can vary to, becoming a cause of ink leakage or errors in relative positions of the ejection opening of the orifice plate 12 with respect to the printing surface of the print medium.

Thirdly, when the frame member 3 is bonded to the ink supply portion 8, upon bonding the frame member 3 to the ink supply portion 8 with reference to the bonding surface of the base 16, a gap is formed between the conductive layer 6 of the frame member 3 and the bonded surface of the ink supply portion 8, which might become a cause of a corrosion of the conductive layer 6 by ink.

### SUMMARY OF THE INVENTION

Considering the problems described above, it is an object of the present invention to provide a liquid ejection print head which performs printing by ejecting a print liquid onto a surface of a print medium and which can minimize variations in the amount of lead forming.

To achieve the above objective, the present invention provides a tape provided with a base, comprising: a base having electrothermal transducers formed therein, the electrothermal transducers being adapted to heat a liquid used for printing and introduced through a liquid introduction passage and to eject the liquid through an ejection port forming surface; and a tape member arranged at a periphery of an accommodating portion where the base is accommodated, and having connecting portions electrically connected to the electrothermal transducers in the base; wherein the tape member includes reinforcement portions having a larger rigidity than that of the connecting portions and connected at one end to electrode portions on the base.

the present invention provides a liquid ejection print head which comprises: the tape provided with a base as above, a conductive layer having connecting portions joined to the tape member, the connecting portions being connected to electrode portions on the base, the electrode portions being electrically connected to the electrothermal transducers and a body having a liquid supply portion for introducing the liquid to the base, wherein the connecting portions include branch portions branched at one end and electrically connected to the electrode portions on the base and reinforcement portions having a larger rigidity than that of the branch portions and connected at one end to the electrode portions on the base.

As can be seen from the explanation above, because the ink-jet printing head of this invention is characterized In that the connecting portions include branch portions branched at one end and electrically connected to the electrode portions on the base and reinforcement portions having a larger rigidity than that of the branch portions and connected at one end to the electrode portions on the base, the base is supported by the branch portions and the reinforcement portions. This can prevent the branch portions from being deformed undesirably easily and minimize variations in the amount of lead forming.

Therefore, the base and the liquid supply portion are bonded together without a gap so that when the liquid is supplied to the base, there is no leakage of the liquid, thus ensuring a satisfactory printed image on a surface of the print medium.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1A is a plan view showing a frame member along with a print element board, used in an embodiment of ink-jet printing head according to the present invention.

FIG. 1B is a perspective view showing flame member being coupled to a print element board.

FIG. 2 is a partial cross-sectional view taken along the line II-II of FIG. 1A.

FIG. 3 is a partial cross-sectional view taken along the line III-III of FIG. 1A.

FIG. 4 is a perspective view showing an embodiment of the ink-jet printing head according to the present invention.

FIG. 5 is a partial cross-sectional view of an embodiment as shown in FIG. 4.

FIG. 6 is a plan view showing another embodiment of the frame member along with the print element board, used in an embodiment of the ink-jet printing head according to the present invention

FIG. 7 is a partial cross-sectional view taken along the line VII-VII of FIG. 6.

FIG. 8 is a partial cross-sectional view taken along the line VIII-VIII of FIG. 6.

FIG. 9 is a plan view showing still another embodiment of the frame member along with the print element board, used in an embodiment of the ink-jet printing head according to the present invention

FIG. 10 is a partial cross section taken along the line X-X of FIG. 9.

FIG. 11 is a perspective view showing a frame member used in a conventional ink-jet printing head.

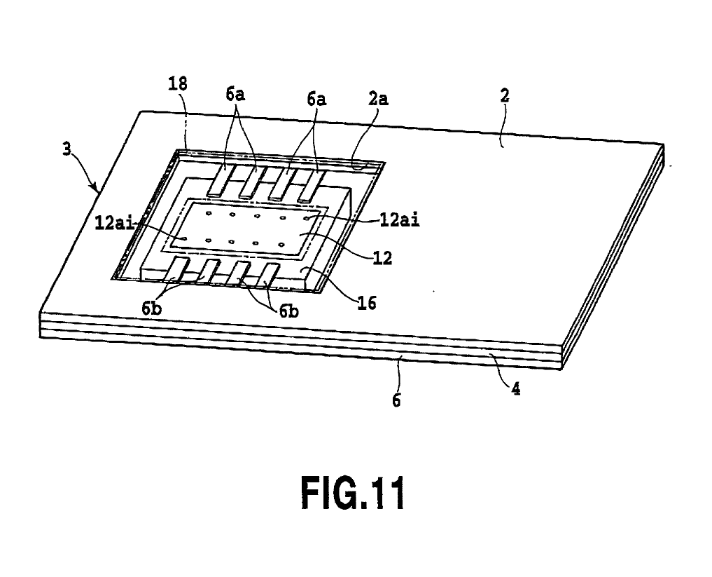

FIG. 12 is a partial cross section of an embodiment as shown in FIG. 11.

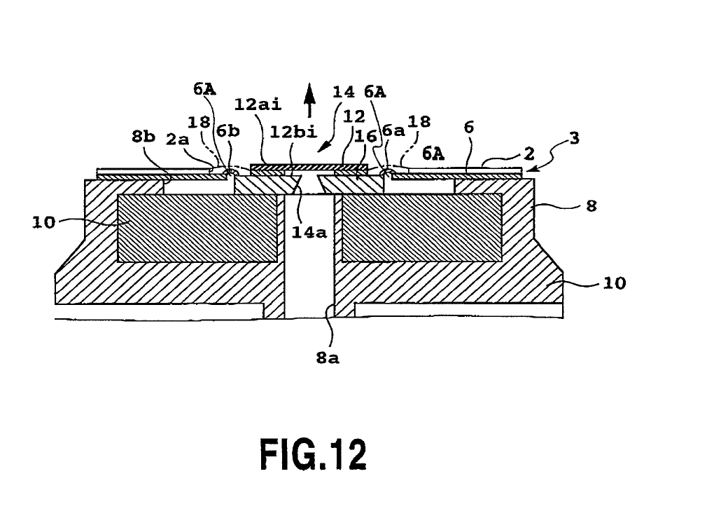

FIGS. 13A, 13B and 13C are partial cross sections used for explanation of the lead forming.

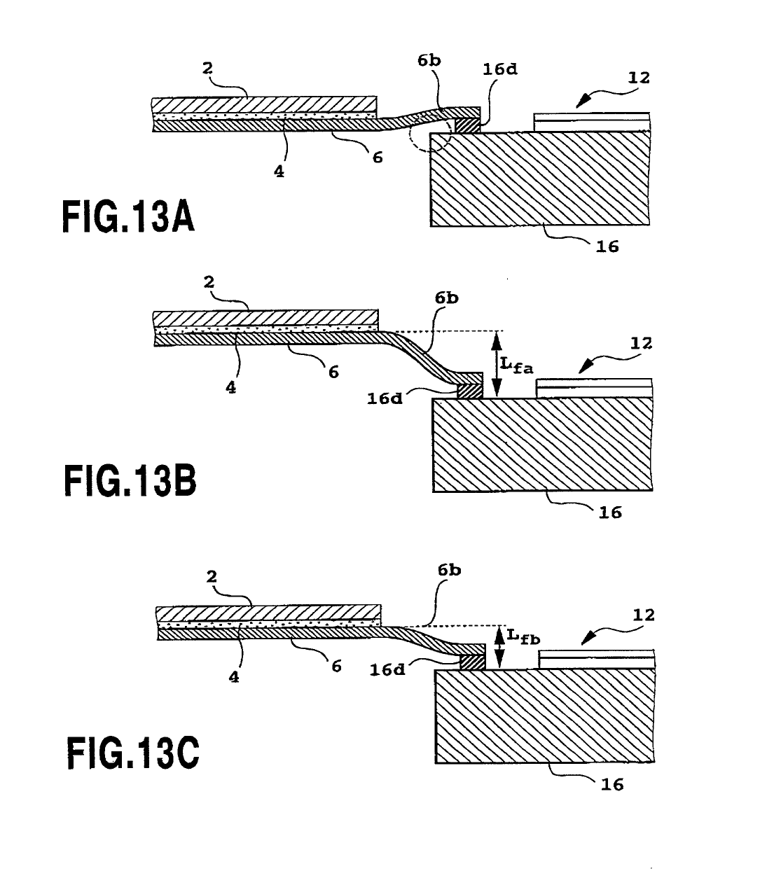

### DETAILED DESCRIPTION OF PREFERRED EMBODIMENTS

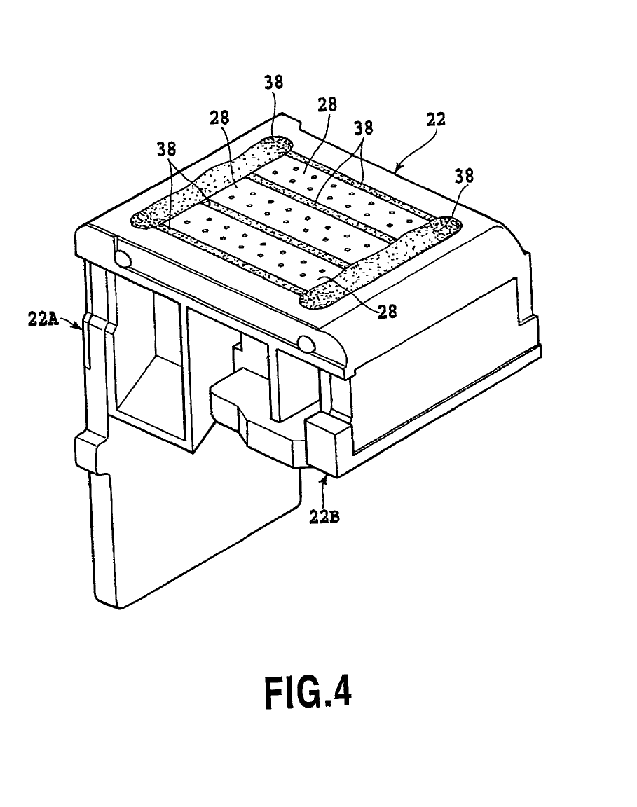

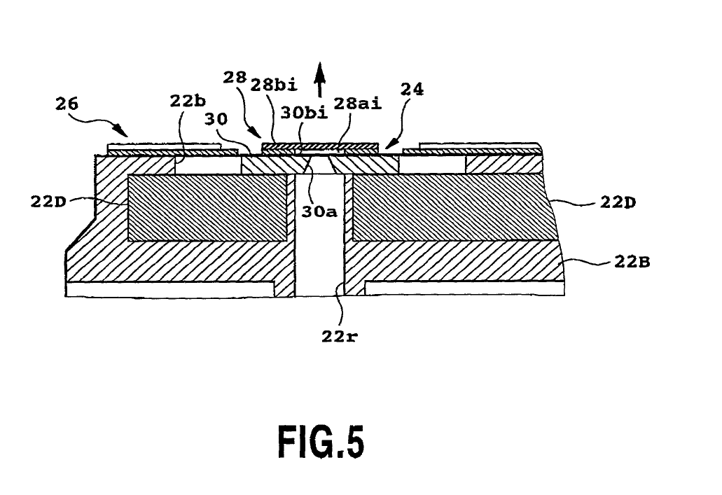

FIG. 4 and FIG. 5 show an external view of the liquid ejection print head according to the present invention and a part of the interior thereof, respectively.

The print head shown in FIG. 4 and FIG. 5 is an ink-jet printing head, for example.

The ink-jet printing head shown in FIG. 4 and FIG. 5 is, for example, of a side shooter type which includes: a body 22 having an ink supply portion 22B to which ink tanks not shown are mounted and an input terminal unit 22A electrically connected to a carriage not shown to receive drive control signals from the carriage; three print element boards 24 bonded to a bonding surface of the ink supply portion 22B of the body 22; and a frame member 26 electrically connected to the three print element boards 24 to supply the drive control signals from the input terminal unit 22A to each print element board 24.

The ink supply portion 22B has a recessed portion 22b in which three print element boards 24 are accommodated. A plurality of ink supply passages 22r for introducing inks from the ink tanks have one of their ends opened at the bottom of the recessed portion 22b, that forms the bonding surface, at positions corresponding to the print element boards 24. Arranged around the ink supply passages 22r is a core member 22D that is formed together with the ink supply portion 22B. The core member 22D is formed flat from, for example, an aluminum alloy material and has a predetermined planarity at its bottom surface.

The periphery of the recessed portion 22b is surrounded by a flat surface to which a frame member 26 described later is bonded.

The print element boards 24 eject inks of different colors, such as yellow, magenta and cyan, respectively.

Each of the print element boards 24 includes a base 30 and an orifice plate 28. The base 30 has an ink supply opening 30a communicating with an open end of the associated ink supply passage 22r in the ink supply portion 22B and heaters 30bi (i=1 to n, n is an integer) arranged on both sides of the ink supply opening 30a. The orifice plate 28 has a plurality of ink supply branch passages 28ai (i=1 to n, n is an integer) that supply ink from the ink supply opening 30a to the heaters 30bi.

The base 30 is formed from, for example, a silicon material into a plate with a predetermined thickness. The surface of the base 30 facing the bottom of the recessed portion 22b is bonded to that bottom. The heaters 30bi in the base 30 are formed from, for example, hafnium boride or tantalum nitride. The heaters 30bi in FIG. 5 are installed at pairs of intersections formed by two parallel longitudinal lines extending perpendicular to the paper plane of the drawing on both sides of the ink supply opening 30a and a number of parallel oblique lines crossing the two longitudinal lines at predetermined intervals (600 dpi) at a predetermined angle. The heaters 30bi at each pair of intersections are arranged to face each other. On the outer circumferential portion of the base 30 including the heaters 30bi, a thin film of, for example, silicon dioxide (SiO₂) is deposited to a predetermined thickness as a protective film against ink. The thin film of silicon dioxide may be formed by sputtering. The heaters 30bi may be tantalum-aluminum (TaAl) anodic-oxidized heaters. In that case, the protective film against ink is not required.

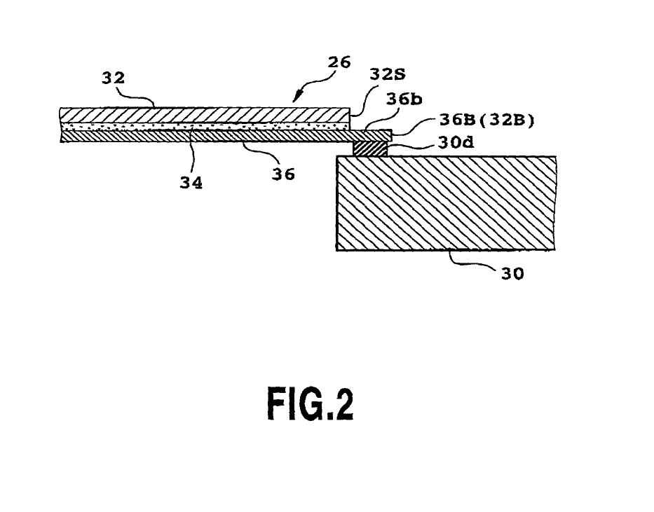

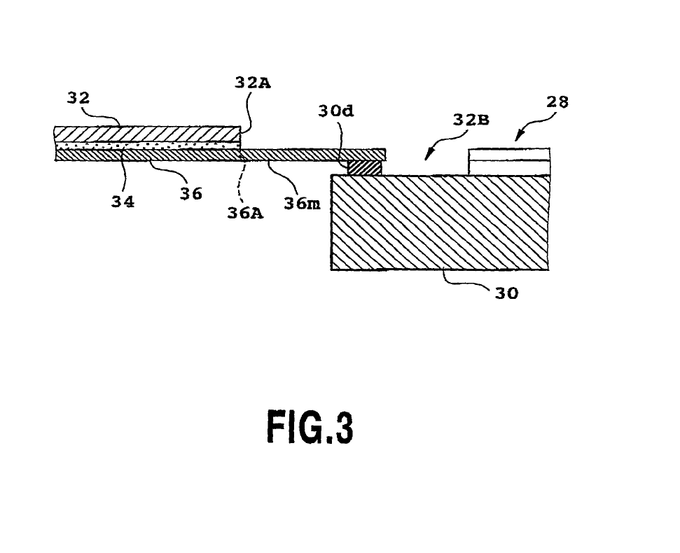

As shown in FIG. 2 and FIG. 3, the heaters 30bi are each electrically connected to electrode bumps 30d through a conductive layer not shown. At each end of the base 30 on its short side the electrode bumps 30d are arrayed in line at predetermined intervals in such a way that they correspond, one to one, to the associated heaters 30bi. The electrode bumps 30d may be formed about 18 μm high from the upper surface of the base 30.

The orifice plate 28 is formed from a thermosetting resin material into a plate with a predetermined thickness. The thermosetting resin material may be composed of 100 parts by weight of a first component (trademark EHPE-3150: Daicel Chemical Industry make), 100 parts of a second component (trademark ADECAOPTOMER SP170: Asahi Denka Gokyo make) and 1.5 parts of a third component (xylene).

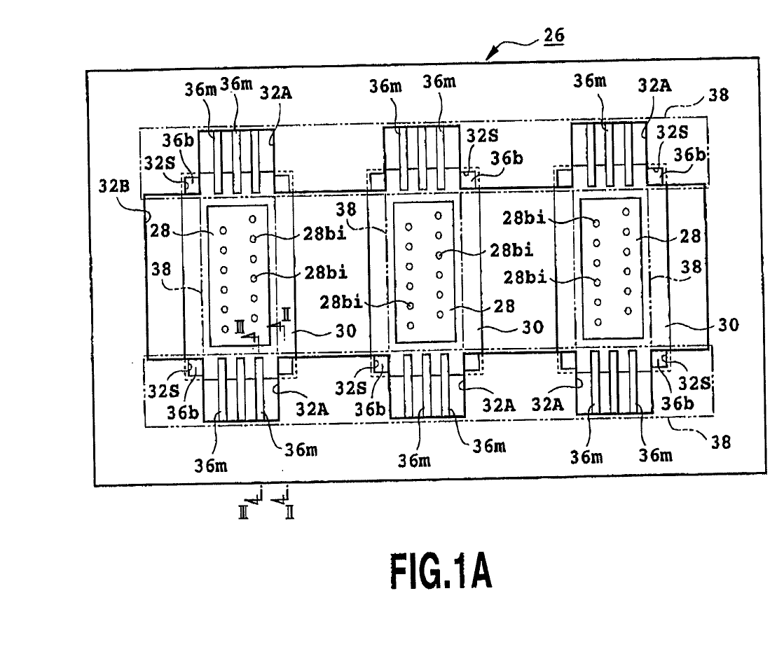

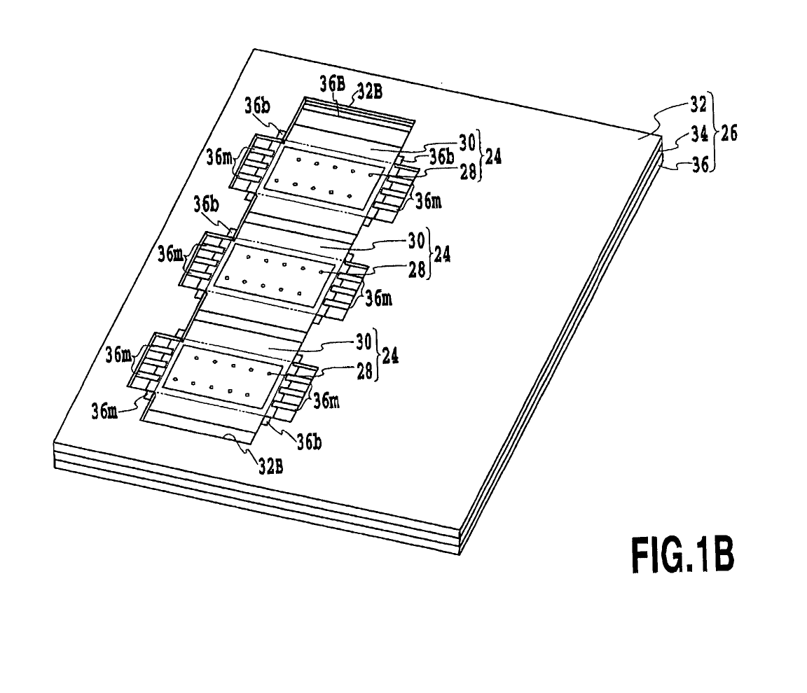

The orifice plate 28 has ink ejection ports 28bi at positions corresponding to the heaters 30bi of the base 30, as shown in FIG. 1A. The number of ink ejection ports may, for example, be set at 128 which is equal to that of the heaters 30bi. FIG. 1A shows an enlarged view of a part of the ink ejection ports. The ink supply branch passages 28ai are separately provided for individual heaters 30bi of the base 30.

The frame member 26 is electrically connected to the electrode bumps 30d of the print element board 24 by the TAB system.

The frame member 26 comprises, as shown in FIG. 1A and FIG. 3, a tape member layer 32 forming an external surface layer and a conductive layer 36 bonded to the inner surface of the tape member layer 32 to be stacked on top of each other through an adhesive layer 34.

The tape member layer 32 is formed of, for example, polyimide resin has a thickness of 50-125 μm and surrounds the periphery of the recessed portion 22b.

The tape member layer 32 has opposed openings 32A, used as so-called device holes, in its inner area responding to at opposing ends of the print element board 24 on its short sides. The tape member layer 32 also has an opening 32B that connects the opposing openings 32A to each other.

The openings 32A are formed in an almost rectangular shape at predetermined intervals to face branches 36m of the conductive layer 36 described later. Base end-sides of the branches 36m in each opening 32A are spaced a predetermined distance from the ends of each print element board 24.

The opening 32B is formed in a rectangle shape extending in a direction of array of the openings 32A. The both ends of the periphery of the opening 32B are spaced a predetermined distance from the ends of the base 30 of the print element boards 24 installed below, respectively.

At corners where the openings 32A and the opening 32B in the tape member layer 32 intersect each other, almost square notches 32s are formed. This causes reinforcing portion 36b of the conductive layer 36 described later to expose through the notch 32s.

The conductive layer 36 is formed, for example, of a copper alloy material has a thickness of about 23 μm. The conductive layer 36 has a plurality of openings 36A in its inner area at positions corresponding to the openings 32A of the tape member layer 32. In the openings 36A, the narrow branches 36m as leads, integrally formed with another portion, responding to electrode bumps 30d. The each branche 36m are bonded at one end to the electrode bumps 30d of the base 30 as by thermo-compression or ultrasonic-vibration ot the like, as shown in FIG. 3, respectively.

The conductive layer 36 has an opening 36B at a position corresponding to the opening 32B of the tape member layer 32.

Further, as shown in FIG. 1B and FIG. 2, the conductive layer 36 has reinforcing portion 36b joined to the electrode bumps 30d which provided at the corners of the base 30. The reinforcing portion 36b bonded to the tape member layer 32 are formed between the laterally adjacent openings 36A for different print element boards 24 and on both sides of the opening 36B, respectively. Those portions of the eight reinforcing portion 36b which face the electrode bumps 30d are joined to and supported by the electrode bumps 30d, respectively. Those portions of the reinforcing portion 36b that face the electrode bumps 30d are not supplied with power when the ink-jet printing head are operated.

The gaps between the peripheries of the openings 32A, 32B of the tape member layer 32 and the outer circumferential portion of the orifice plate 28 and also the mutual gaps between the orifice plates 28 are sealed with a predetermined sealant 38.

Accordingly, when the reinforcing portion 36b of the conductive layer 36 are bonded to the electrode bumps 30d along with the branches 36m of the conductive layer 36, and the lead forming is performed with the frame member 26 and the print element board 24 connected as shown in FIG. 1B, since the print element boards 24 are more firmly supported by the branches 36m and the reinforcing portion 36b of the conductive layer 36, which are bonded to the tape member layer 32, the rigidness of the supporting is enhanced, each branches 36m dose not easily become deformed.

This prevents the branches 36m from being deformed undesirably easily during the lead forming, thus minimizing variations in the amount of lead forming among the print element boards 24.

Then, the frame member 26 and the print element board 24, both of which have been positioned relative to each other and subjected to the lead forming, are bonded to their predetermined positions on the ink supply portion 22B of the body 22.

While in this example the reinforcing portion 36b are formed as a part of the conductive layer 36 bonded to the tape member layer 32, but it is not limited to this example, for example, it Is possible to use as the reinforcing portion those portions of the tape member layer 32 bonded to the print element board 24 that have a relatively high stiffness.

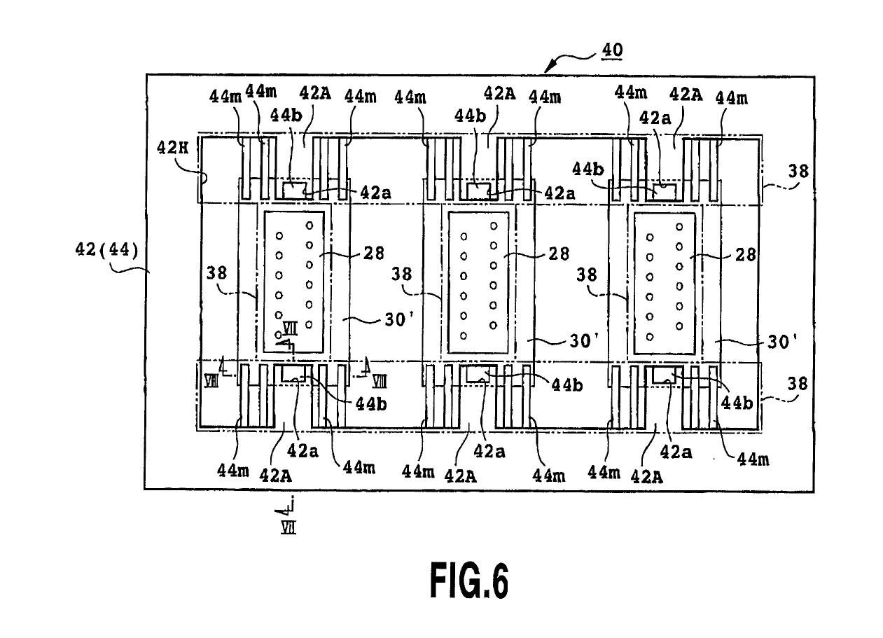

FIG. 6 shows another example of the frame member in an example liquid ejection print head of the present invention.

In the example shown in FIG. 1A, the reinforcing portion 36b are provided between the laterally adjacent openings 32A and at the intersecting portions between the openings 32A and the opening 32B. In the example shown in FIG. 6, reinforcing portion 44A are provided between each branche 44m for each base 30′.

In the example of FIG. 6 and in other examples described later, constitutional elements identical with those of FIG. 1A are given like reference numbers and their explanations are omitted.

In FIG. 6, a frame member 40 is electrically connected to electrode bumps 30′d of the bases 30′ by the TAB system.

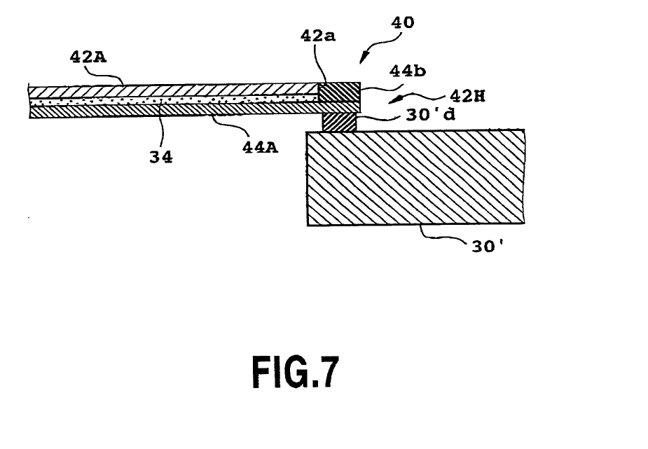

As shown in FIG. 6 and FIG. 7, the frame member 40 comprises a tape member layer 42 forming an outer surface layer and a conductive layer 44 bonded to an inner surface of the tape member layer 42 to be stacked on top of each other through an adhesive layer 34.

The tape member layer 42 is formed of, for example, polyimide resin has a thickness of 50-125 μm and has an almost rectangular opening 42H, used as a so-called device hole, in its inner area.

The periphery of the opening 42H is spaced a predetermined distance from the outer circumferential portion of each print element board 24 installed at the bottom of the recessed portion 22b below.

Those portions of the periphery of the opening 42H which oppose the bases 30′ are integrally formed with projections 42A protruding inwardly on the same plane. At their front end of projections 42A are each formed a notch 42a. Thus, a part 44b of each reinforcement 44A of the conductive layer 44 described later is exposed through the notch 42a.

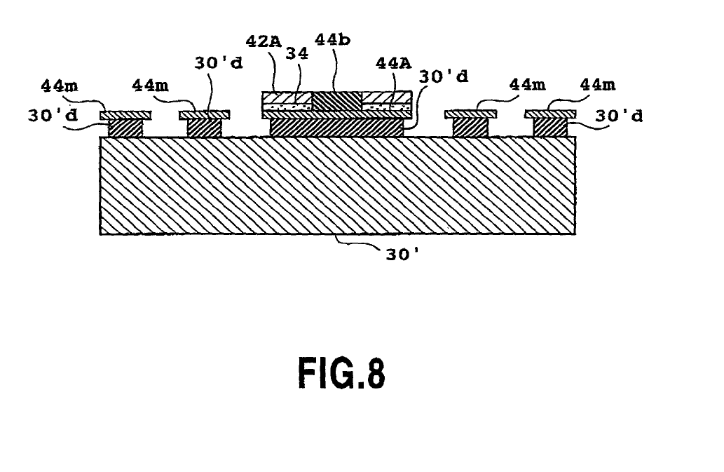

The conductive layer 44 is formed of, for example, a copper alloy material has a thickness of about 23 μm and has an opening 44H in its inner area at a position corresponding to the opening 42H of the tape member layer 42. In the opening 44H one end of elongate branches 44m as leads, whose base portions of the branches 44m are integrally formed with the conductive layer 44, protrudes corresponding to electrode bumps 30′d. The branches 44m are bonded at one end to the electrode bumps 30′d of the base 30′ as by thermo-compression or ultrasonic- vibration or the like, as shown in FIG. 8.

As shown in FIG. 7, the conductive layer 44 has reinforcing portion 44A bonded to the electrode bumps 30′d which provided at around centers of the both ends of the base 30′. The reinforcing portion 44A provided between the adjacent branches 44m are bonded to the base 30′ below the projections 42A, respectively. The portions 44b of the six reinforcing portion 44A that face the electrode bumps 30′d are bonded to the electrode bumps 30′d. Those portions 44b of the reinforcing portion 44A facing the electrode bumps 30′d are not supplied with power when the ink-jet printing head are operated.

The gap between the periphery of the opening 42H of the tape member layer 42 and the outer circumferential portions of the orifice plates 28 and the gap between the orifice plates 28 are sealed with a predetermined sealant 38.

Accordingly, when the reinforcing portion 44A of the conductive layer 44 are bonded to the electrode bumps 30′d along with the branches 44m of the conductive layer 44 and the lead forming is performed, since the bases 30′ are more firmly supported by the each branches 44m and the reinforcing portion 44A, which are bonded to the projections 42A, the rigidness of the supporting is enhanced, each branches 44m dose not easily become deformed.

This prevents the branches 44m from being deformed undesirably easily during the lead forming. As a result, the effect similar to that described above can be obtained.

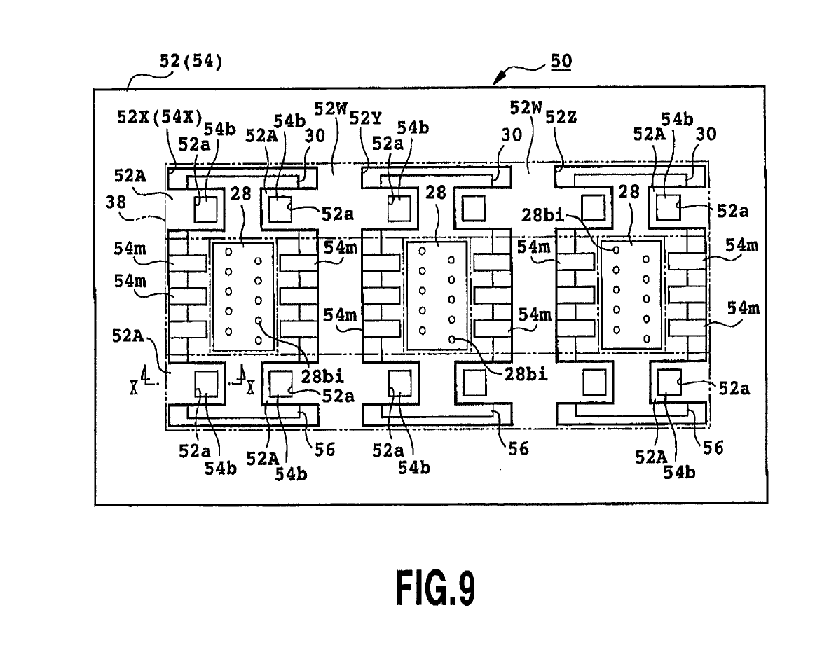

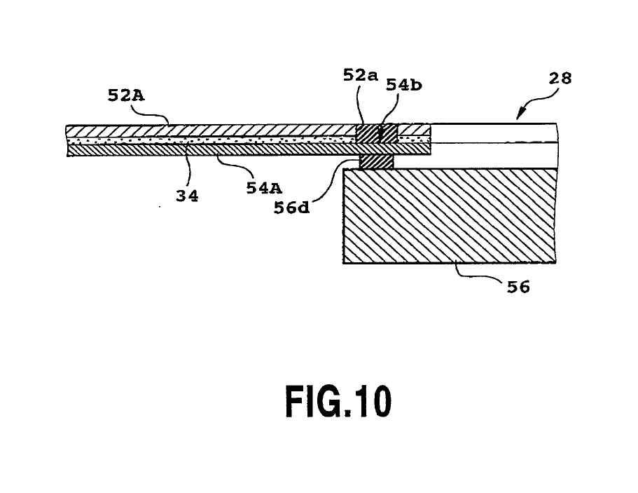

FIG. 9 and FIG. 10 show a still further example of the frame member in an embodiment of liquid ejection print head of the present invention.

In the example shown in FIG. 1A, a single opening 32B of the tape member layer 32 is formed to enclose the three orifice plates 28 arranged below. In the example shown in FIG. 9 and FIG. 10, a tape member layer 52 has three separate openings 52X, 52Y, 52Z formed therein, each facing the associated office plate 28.

The openings 52X, 52Y, 52Z of the tape member 52 have the same structures each other and thus the structure of only the opening 52X and its periphery will be described. The explanation of the structure of another openings 52Y,and 52Z are omitted.

At each end of a base 56 on its long side, electrode bumps 56d are arranged along the direction of array of the Ink ejection ports 28bi in the orifice plate 28, respectively.

A frame member 50 is electrically connected to the electrode bumps 56d of the base 56 by the TAB system.

The frame member 50 comprises a tape member layer 52 forming an outer surface layer and a conductive layer 54 bonded to the inner surface of the tape member layer 52 to be stacked on top of each other through an adhesive layer 34.

The tape member layer 52 is formed of, for example, polyimide resin has a thickness of 50-125 μm and has an almost rectangular opening 52X, used as a so-called device hole, in its inner area.

The periphery of the opening 52X is spaced a predetermined distance from the outer circumferential portion of the base 56 installed at the bottom of the recessed portion 22b below.

The periphery portion of the opening 52X opposing to the base 56 has integrally formed therewith four opposing projections 52A that protrude inwardly on the same plane toward the base 56 each other. At front end of each of the projections 52A is formed an almost square notch 52a, through which a part 54b of a reinforcement 54A of the conductive layer 54 described later is exposed.

The conductive layer 54 is formed of, for example, a copper alloy material has a thickness of about 23 μm and has in its inner area an opening 54X at a position corresponding to the opening 52X of the tape member layer 52. In the opening 54X, elongate branches 54m as leads, whose base portions are integrally formed with the conductive layer 54, protrudes corresponding to each electrode bump 56d. The branches 54m are bonded at one end to the electrode bumps 56d of the base 56 as by thermo-compression or ultrasonic vibration, as shown in FIG. 10.

The conductive layer 54 has four reinforcing portion 54A bonded at one end to those electrode bumps 56d on the base 56 which are provided on both sides of a group of other electrode bumps to which the branches 54m are bonded at one end. The reinforcing portion 54A extend under and are bonded to the associated projections 52A. Those portions 54b of the four reinforcing portion 54A which face the electrode bumps 56d are bonded to them. The portions 54b of the reinforcing portion 54A facing the electrode bumps 56d are not supplied electricity when the ink-jet printing head are operated.

The gap between the periphery of the opening 52X in the tape member layer 52 and the outer circumferential portion of the orifice plate 28 and the gap between the orifice plates 28 are sealed with a predetermined sealant 38.

Since the reinforcing portion 54A of the conductive layer 54 are bonded to the electrode bumps 56d along with the branches 54m of the conductive layer 54, the bases 56 are more firmly supported by the reinforcing portion 54A, which are bonded to the projections 52A, than when supported only by the branches 54m. This prevents the branches 54m from being deformed undesirably easily during the lead forming. As a result, the effect similar to that described above can be obtained.

In the examples described above, although the ink-jet printing head has been described to eject inks of various colors, it may also eject a processing liquid that renders inks insoluble.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. A tape provided with a base, comprising:
a base having electrothermal transducers formed therein, the electrothermal transducers being adapted to heat a liquid used for printing and introduced through a liquid introduction passage and to eject the liquid through an ejection port forming surface; and
a tape member arranged at a periphery of an accommodating portion where the base is accommodated, and having connecting portions electrically connected to said electrothermal transducers in said base;
wherein said tape member includes reinforcement portions having a larger rigidity than that of said connecting portions and connected at one end to electrode portions on said base.

2. A tape provided with a base according to claim 1, wherein said reinforcement portions are arranged to face corners of said base.

3. A tape provided with a base according to claim 1 wherein said reinforcement portions are arranged to face an almost central part of each of opposing ends of said base.

4. A tape provided with a base according to claim 1, wherein said reinforcement portions are arranged to face opposing ends of said base and installed at a plurality of locations on each of said opposing ends.

5. A tape provided with a base according to claim 1, wherein parts of said tape member facing one end of said reinforcement portions each have a notched portion.

6. A tape provided with a base according to claim 1, wherein, below an opening formed in a part of said tape member that faces said accommodating portion there are arranged a plurality of said bases to each of which said reinforcement portions are connected.

7. A tape provided with a base according to claim 6, wherein said opening is divided into a plurality of openings, one for each base.

8. A tape provided with a base according to claim 1, wherein, below an opening formed in a part of said tape member that faces said accommodating portion there is arranged one of said base.

9. A liquid ejection print head comprising:
a tape provided with a base as claimed in claim 1,
a conductive layer having connecting portions joined to said tape member, said connecting portions being connected to electrode portions on said base, said electrode portions being electrically connected to said electrothermal transducers;and
a body having a liquid supply portion for introducing said liquid to said base,
wherein said connecting portions include branch portions branched at one end and electrically connected to said electrode portions on said base and reinforcement portions having a larger rigidity than that of said branch portions and connected at one end to said electrode portions on said base.

10. A liquid ejection print head according to claim 9, wherein said reinforcement portions of said connecting portions are arranged to face corners of said base.

11. A liquid ejection print head according to claim 9, wherein said reinforcement portions of said connecting portions are arranged to face an almost central part of each of opposing ends of said base.

12. A liquid election print head according to claim 9, wherein said reinforcement portions of said connecting portions are arranged to face opposing ends of said base and installed at a plurality of locations on each of said opposing ends.

13. A liquid ejection print head according to claim 9, wherein parts of said tape member facing one end of said reinforcement portions of said connecting portions each have a notched portion.

14. A liquid ejection print head according to claim 9, wherein, below an opening formed in a part of said tape member that faces said accommodating portion there are arranged a plurality of said bases to each of which said reinforcement portions are connected.

15. A liquid ejection print head according to claim 14, wherein said opening is divided Into a plurality of openings, one for each base.

16. A liquid ejection print head according to claim 9, wherein, below an opening formed in a part of said tape member that faces said accommodating portion there is arranged one of said base.

17. A liquid ejection print head according to claim 9, wherein said branch portions and said reinforcement portions of said connecting portions are arranged in a direction of array of ejection ports in said ejection port forming surface.

18. A liquid ejection print head according to claim 9, wherein said branch portions and said reinforcement portions of said connecting portions are arranged in a direction perpendicular to said direction of array of ejection ports in said ejection port forming surface.

19. A liquid ejection print head according to claim 9, wherein said liquid is an ink or a processing liquid for rendering said ink insoluble.
